(19) United States
(12) Patent Application Publication
(10) Pub. No.: US 2006/0272197 A1
(43) Pub. Date: Dec. 7, 2006

(54) Trap for rodents, in particular for mice and rats

(76) Inventors: Bernd Wiesener, Berlin (DE); Mark Wiesener, Berlin (DE)

Correspondence Address: NOTARO AND MICHALOS, 100 DUTCH HILL ROAD, SUITE 110, ORANGEBURG, NY, 10962-2100, US

(21) Appl. No.: 11/145,719

(22) Filed: Jun. 6, 2005

(51) Int. Cl. A01M 23/30

(52) U.S. Cl. 43/81

(57) ABSTRACT

The invention pertains to a trap for rodents, particularly for mice and rats, with a trigger device in the form of a plate (10) that is supported in a rocker-like fashion and provided with a constantly accessible receptacle for accommodating bait, with a striking device that is supported on the base plate (1) such that it can be pivoted about a first axis (7), wherein the striking device can be subjected to the force of a tension spring (18) and released from a first, armed position when an animal acts upon the plate such that it is pivoted about a second axis (9) supported on the base plate (1) from an idle position into a triggering position, in which a release element in the form of an eccentrically supported, elastic driving element that is separably engaged with the striking device (8) in the first, armed position can be pivoted by the rocker-like plate (10), wherein the striking device (8) that can be pivoted about the first axis (7) is released from its first, armed position and the force of the tension spring (18) causes the striking device to instantly swing with a high striking force into a second position, in which it humanely kills the animal. Due to its rotative moment, the eccentrically supported elastic driving element (17) is always rotationally prestressed in the direction of its home position, in which a collar (35) of the driving element (17) is engaged with an abutment (27) of the plate (10), wherein the striking device (8) is separably locked in its first, armed position on the driving element (17). The collar (35) of the driving element (17) that is tensioned during the movement of the latter into the release position such that the driving element (17) is turned back in the direction of its home position due to the spring-back of the spring arm (36).

### SUBJECT AREA AND BACKGROUND OF THE INVENTION

The invention pertains to a trap for small rodents, particularly for mice and rats, with a base plate that is provided with a receptacle for accommodating bait, with a striking device that is supported on the base plate such that it can be pivoted about a first axis, wherein the striking device can be subjected to the force of a tension spring and released from a first, armed position when an animal acts upon a trigger device such that it is pivoted about a second axis supported on the base plate from an idle position into a triggering position, in which a release element that is engaged with the striking device in the first, armed position can be pivoted by the trigger device in such a way that the striking device that can be pivoted about the first axis is released from its first, armed position and the force of the tension spring causes the striking device to instantly swing into a second position, in which it strikes and kills the animal, wherein the striking device extending from the first axis is provided with a first and a second arm, wherein a first mounting point of the tension spring is arranged on the end of the striking device that can be turned by the first axis of the first arm, wherein the second mounting point of the tension spring is arranged on the frame, wherein the line of force between the two mounting points of the tension spring extends through or in the vicinity of the first axis when the striking device is situated in its first, armed position, and wherein the trigger device encompasses the opening of the receptacle for accommodating the bait at least in its idle position and the opening of the receptacle for accommodating the bait is freely accessible in the triggering position of the trigger device.

In a trap of this type that is known from EP 1 011 326 B1, the trigger device is formed by a hood-like cap that can be pivoted about the second axis and covers the receptacle for accommodating the bait that is situated in the base plate of the trap in the idle position of the trigger device. The cap is provided with a recess on its opposite end face referred to the first axis and with an arm section forming the release element on the opposite end referred to said recess. In its first, armed position, this release element is engaged with the first arm of the striking device and the striking device is separably locked in this position. The second arm of the striking device rests against a limit stop that prevents the striking device from being unintentionally turned and rendering the trap effective. In the armed position, the striking device is subjected to the tensile force of the tension spring that is realized in the form of a coil spring and fixed on the second arm of the striking device and on the second end of the base plate.

In order to trigger this known trap, the hood-like cap covering the bait needs to be raised by the animal from its recess on the end face. This results in a pivoting movement of the cap that, in turn, causes the release element that can be pivoted about the first axis together with the cap to act upon the second arm of the striking device, namely in such a way that the striking device swings into its second position under the influence of tension spring and strikes and kills the animal. The efficiency of this trap is limited because it cannot be ensured that an animal to be trapped raises the hood-like cap. In addition, this trap is not stackable due to its elevated construction on the second end of the base plate.

DE 100 36 990 A1 also discloses a mousetrap with a striking element that is coupled to a base plate, wherein a striking spring is tensioned when the striking element is set to the trapping position. This mousetrap also contains a trigger that is designed in a rocker-like fashion and releases the striking element from the trapping position when it is slightly pivoted such that the striking element swings shut under the influence of the striking spring.

### SUMMARY OF THE INVENTION

The invention is based on the objective of developing a trap of the initially described type that is intended, in particular, for use in private households and agricultural farming, especially in poultry farming, and makes it possible to efficiently kill small rodents, particularly mice and rats, in a humane fashion with a high a striking force, wherein even inexperienced persons should be able to comfortably operate the trap with one hand. In addition, the trap should be designed in a stackable fashion in order to reduce the space requirement and the shipping costs. It should also be possible to equip the trap with a suitable housing in order to improve the safety for children, pets and animals other than those targeted in comparison with poisonous baits, wherein said housing also allows an ecologically sound disposal of trapped animals or animal cadavers and the consideration of the edge contact behavior of rodents by directly fixing the trap on walls, particularly on the ground when the trap is used in farms for ground-dwelling animals.

According to the invention, this objective is attained with the trap described in claim 1. This trap is primarily characterized in that

the trigger device is formed by a plate that can be pivoted about the second axis of the base plate in a rocker-like fashion, namely above the latter, and is arranged parallel to the base plate in its idle position, wherein said plate contains a recess in the vicinity of its first end which encompasses the opening of the bait receptacle of the base plate such that it is constantly accessible, and wherein the opposite second end of this plate contains an abutment that extends upward from the upper surface of the plate, and in that

the release element is formed by an elastic driving element that is eccentrically supported on the base plate on a third axis thereof in the vicinity of the second plate end, namely such that its rotative moment causes the driving element to be turned into a home position, in which a collar of the driving element is engaged with the abutment of the plate and the striking device is separably locked on the driving element in its first, armed position, wherein the third axis is arranged between the first end of the rocker-like plate and the first axis and the second mounting point of the tension spring is arranged on the base plate between the second axis and the first end of the plate. When the first end of the rocker-like plate is acted upon in the direction toward the base plate, the collar of the driving element is acted upon by the abutment of the plate and the eccentrically supported driving element is prestressed opposite to its rotative moment, namely into a position that releases the locked striking device from its first, armed position, wherein the released striking device instantly pivots into its second position due to the force of the tension spring, wherein a spring arm of the driving element that is arranged opposite to the collar thereof is tensioned into its release position, and wherein the driving element is always turned back into its home position due to the spring-back of the spring arm.

The trap according to the invention not only is highly efficient and has an exceptionally high striking force, but also makes it possible to comfortably operate the trap with one hand. This is achieved due to the utilization of a specially designed release element in the form of a driving element that is eccentrically supported and can be separably engaged with the striking device, wherein the release element is functionally connected to the trigger device in the form of a plate that is supported in a rocker-like fashion and provides direct access to the bait. The aforementioned advantages are also attained due to the special arrangement of the mounting points of the tension spring that acts upon the striking device.

Advantageous additional developments of the trap according to the invention are described in Claims 2-10.

For example, a holding device is preferably provided adjacent to the second end of the rocker-like plate on the second end of the base plate such that it extends upward from the upper surface of said base plate. The third axis for eccentrically supporting the driving element in a pivotable fashion is held on this holding device, wherein the holding device also contains a limit stop that is contacted by the spring arm of the driving element in its release position and tensions the spring arm due to its spring-back, namely such that the driving element is turned back into its home position. In addition, the first, the second and the third axis are arranged horizontally referred to the base plate in a parallel fashion, namely above the base plate, and the first axis is arranged between the second axis and the third axis. In this case, the first and the second axis lie in one plane while the third axis is situated underneath the latter.

A high efficiency of the trap can also be achieved in instances, in which a mouse laterally approaches the trigger device. In this respect, wall-like elements originating at the first end of the rocker-like plate are preferably arranged on the base plate such that they respectively extend over approximately one-third of the plate length, wherein these wall-like elements extend upward from the upper surface of the base plate as far as the plane, in which the upper surface of the rocker-like plate lies in its home position, and wherein the wall-like elements are situated inside the striking device in its second position such that they form a guillotine-like unit for humanely killing the mouse together with the striking device that instantly swings into its second position when a mouse approaches the rocker-like plate from a longitudinal side of the base plate and thusly acts upon the trigger device.

In order to increase the striking force, the first arm and the second arms of the striking device preferably form a right angle, wherein the second arms are inclined relative to the base plate normal by an angle α of approximately 15 °, namely in the direction of the second position of the striking device, in the first, armed position of the striking device. In addition, the rocker-like plate forming the trigger device preferably contains a recess that extends in its longitudinal direction and in which a holding element is accommodated which extends upward from the upper surface of the base plate, wherein the second mounting point of the tension spring is situated on said holding element.

The trap according to the invention makes it possible to significantly reduced storage capacities and shipping costs due to the fact that a plurality of identical traps can be stacked into a compact unit when the striking device of the trap is situated in the second position. In this case, the base plates of the stacked traps lie parallel to one another and the first arm of the striking device is respectively accommodated in a recess in the base plate of the trap lying directly thereon within the compact unit. In addition, the distance between the base plates of the stacked traps is respectively smaller than the height of the striking part of the striking device referred to the upper surface of the base plate in the second position of the striking device.

The trap can be equipped with an exterior housing or arranged in a protected location within such a housing in order to allow an ecologically sound disposal of trapped animals and animal cadavers and to simultaneously improve the safety for children, pets and animals other than those targeted. In this case, the housing is provided with at least a first opening, wherein the size and the arrangement of said opening are chosen such that animals of a desired maximum size are able to gain access to the trigger device of the trap. According to the invention, this housing of the trap is preferably formed by a bait box with locking elements that are arranged on the housing bottom and engage in a separably interlocking fashion into locking grooves on each longitudinal edge of the base plate, as well as on the second lateral edge of the base plate of the trap that is situated adjacent to the release element, when the trap is inserted into the housing. The bait box has—viewed in the form of a cross section through the housing—side walls that extend conically referred to the housing bottom in such a way that a rodent, e.g., a mouse, is unable to pass between the side walls of the housing and the longitudinal sides of the trap inserted into the latter, and that the mouse is directly steered to the trigger device. A housing cover that is hinged to one side wall of the housing securely covers the trap inserted into the housing in the first, armed position as well as the second position (trapping position) of the striking device. The housing cover can be removably attached by means of corresponding snap-on elements arranged on the housing cover and on the other side wall of the housing. In order to ensure a so-called “head-on” result, the housing bottom is provided with a recess in the access region that is situated in front of the first lateral edge of the base plate of the trap inserted into the housing. A mouse entering the housing through the opening is able to walk on the natural ground of the respective trap installation site in this access region, namely in the direction of the base plate receptacle containing the bait and consequently in the direction of the trigger device of the trap.

The end face of the trap housing that contains the access opening may be realized in the form of an exchangeable element such that end walls with access openings of different sizes can be used in accordance with the respective requirements. In addition, the access region of the trap housing preferably has such a length that a finger inserted into the access opening of the housing cannot reach the trigger device of the inserted trap and be injured by the striking device, e.g., a length of more than 10 cm.

The housing of the trap can be divided into two identical housing halves by means of a central partition wall. This makes it possible to realize a mirror arrangement of two identically designed traps arranged in the respective housing halves.

In order to prevent rodents from passing between the housing of the trap and an adjacent building wall, i.e., to take into consideration the typical edge contact behavior of rodents, the outer surface of one of the housing side walls that are arranged conically referred to the housing bottom may extend—viewed in the form of a cross section through the housing—vertically upward from the housing bottom on both of its longitudinal ends and in alignment with its upper longitudinal edge, namely to such a height that the housing of the trap can be fixed on a building wall and a rodent is unable to pass between the corresponding side wall of the housing and the building wall. In addition, the housing can be inserted into an identical housing for stacking purposes in this case.

The housing of the trap and the trap itself—with the exception of the tension spring—are. preferably manufactured from polypropylene (PP).

Embodiments of the trap according to the invention are described below with reference to the figures.

### BRIEF DESCRIPTION OF THE FIGURES

FIG. 1 shows a perspective side view of one preferred embodiment of the trap, wherein the striking device is situated in a first, armed position;

FIG. 2 shows a corresponding perspective side view of the embodiment according to FIG. 1, wherein the striking device is situated in its second position;

FIG. 3 shows a perspective side view of the base plate used in the embodiment according to FIG. 1;

FIG. 4 shows a corresponding perspective side view of the base plate according to FIG. 3, however, with a recess for attaching or taking hold of the trap which is arranged on the first end of the base plate;

FIG. 5 shows a perspective representation of the underside of the rocker-like plate forming the trigger device in the embodiment according to FIG. 1, namely after turning the plate about its transverse axis by 180°;

FIG. 6 shows a top view of the embodiment in the position of the striking device illustrated in FIG. 2;

FIG. 7 shows a bottom view of the embodiment according to FIG. 1;

FIG. 8 shows a perspective representation of the striking device used in the embodiment according to FIG. 1 without its striking part;

FIG. 9 shows a perspective representation of the striking part of the striking device used in the embodiment according to FIG. 1, namely viewed in the direction of the end face of the striking part;

FIG. 10 shows a perspective representation of the coil spring that forms the tension spring used in the embodiment according to FIG. 1;

FIG. 11 shows a perspective side view of a driving element with spring arm which forms the release element used in the embodiment according to FIG. 1;

FIG. 12 shows a side view of two stacked traps according to FIG. 1, wherein the striking device of each trap is respectively situated in the second position according to FIG. 2;

FIG. 13 shows a perspective representation of the outer housing of the trap viewed in the direction of one end face of the housing, wherein the end wall of the housing is removed and the striking device of the trap is illustrated in its first, armed position;

FIG. 14 shows a top view of the housing of the trap, wherein the housing cover is pivoted into the open position and no trap is inserted into the housing;

FIG. 15 shows a side view of the housing with the housing cover in the closed position;

FIG. 16 shows a side view of the housing with a mirror arrangement of traps in two housing halves, wherein the striking device is illustrated in its first, armed position and the housing cover is illustrated in its closed position, and wherein the side wall of the housing that lies in the viewing direction is not illustrated in this figure;

FIG. 17 shows a top view of the housing according to FIG. 16 with a mirror arrangement of traps, however, with the housing cover in the open position, and

FIG. 18 shows a front view of the end wall of the housing that contains the access opening and a perpendicularly extending side wall, wherein the housing cover is illustrated in the open position.

### DESCRIPTION OF PREFERRED EMBODIMENTS

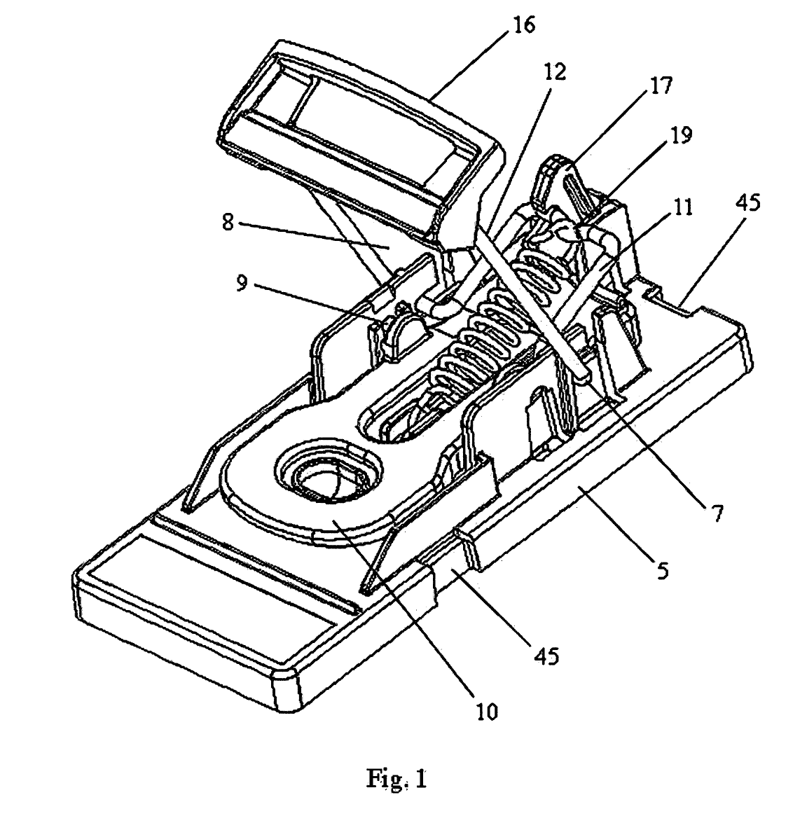

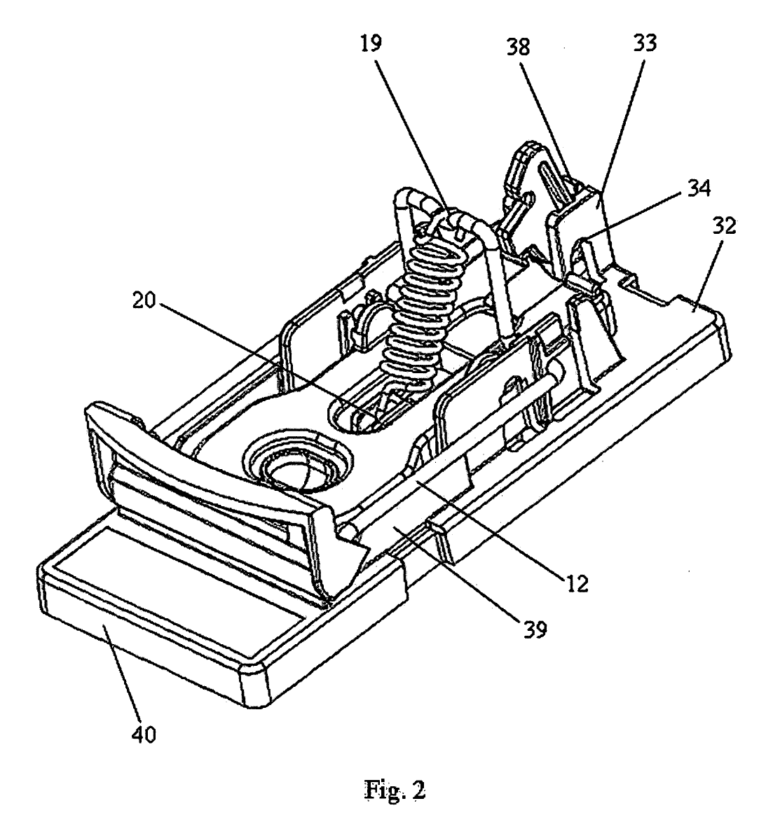

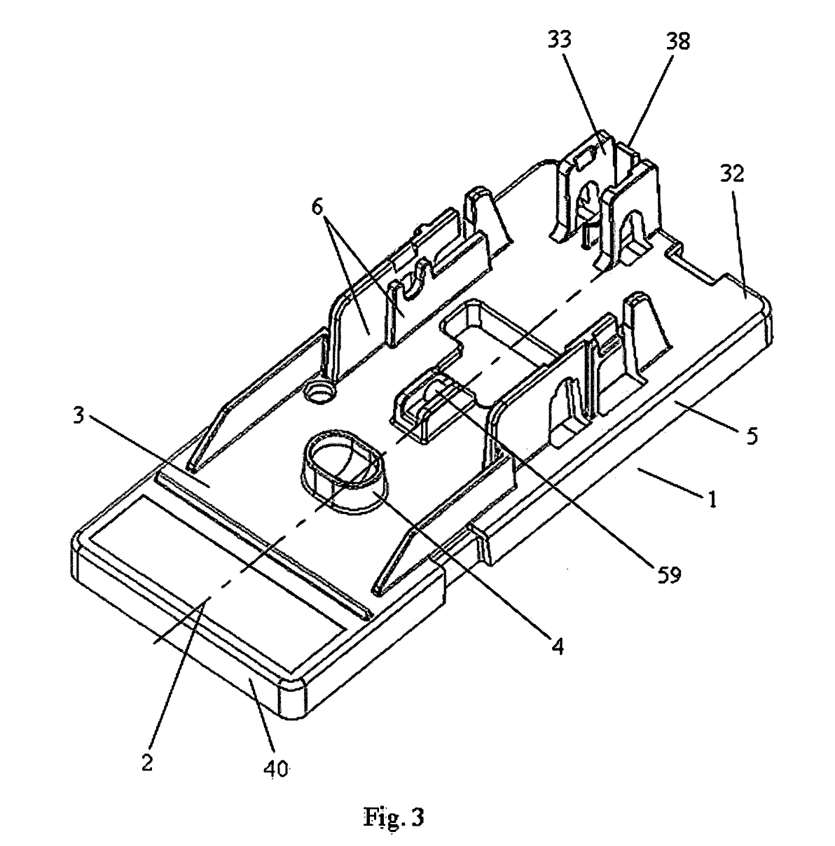

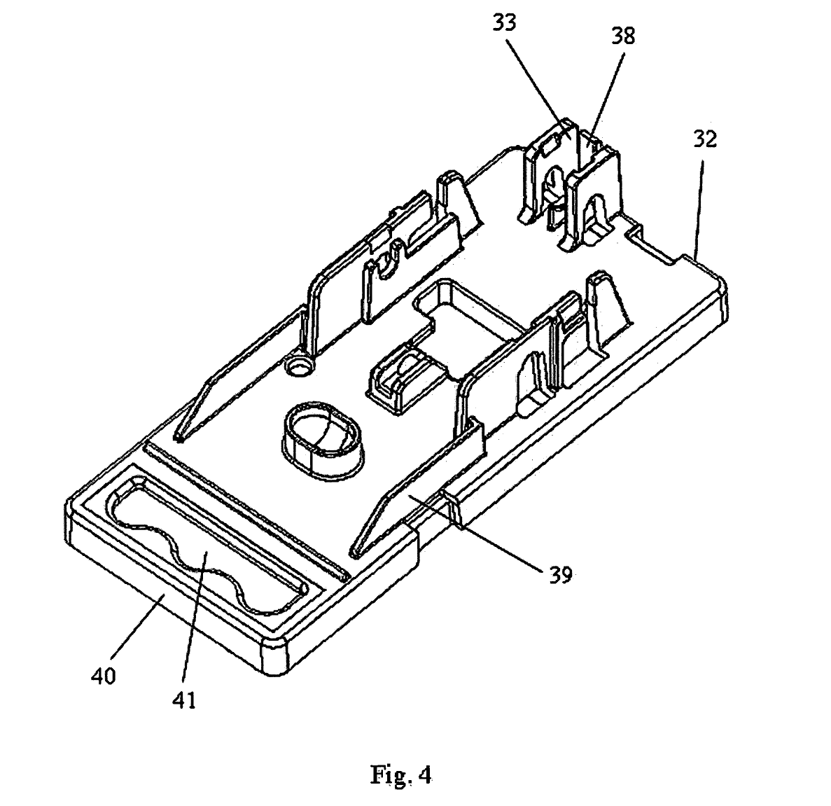

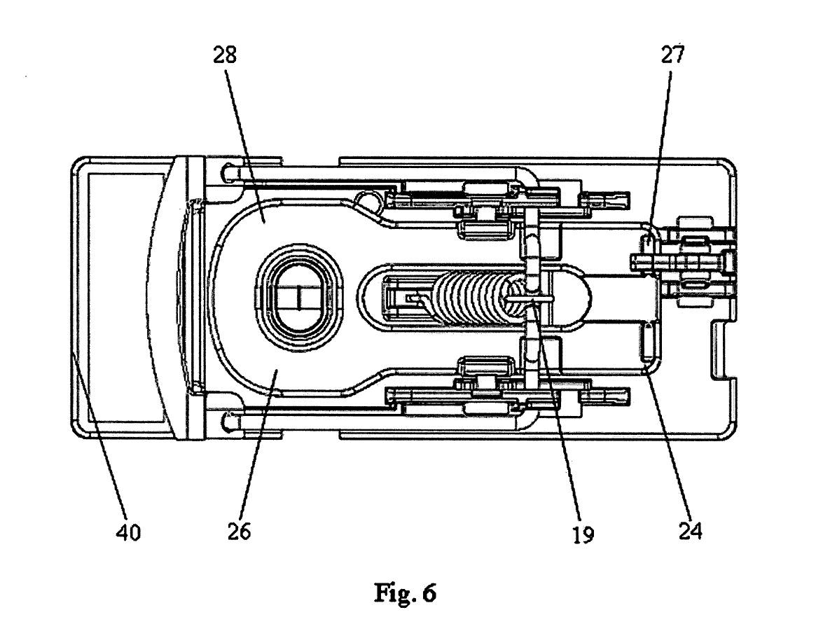

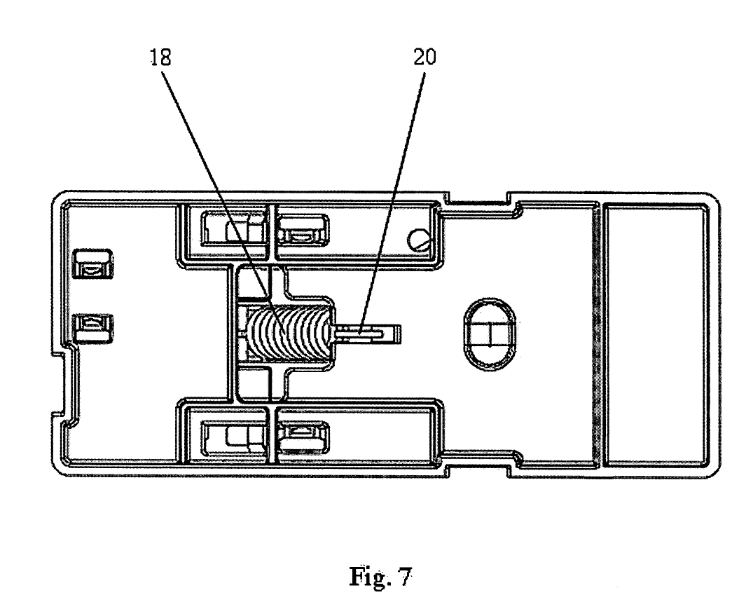

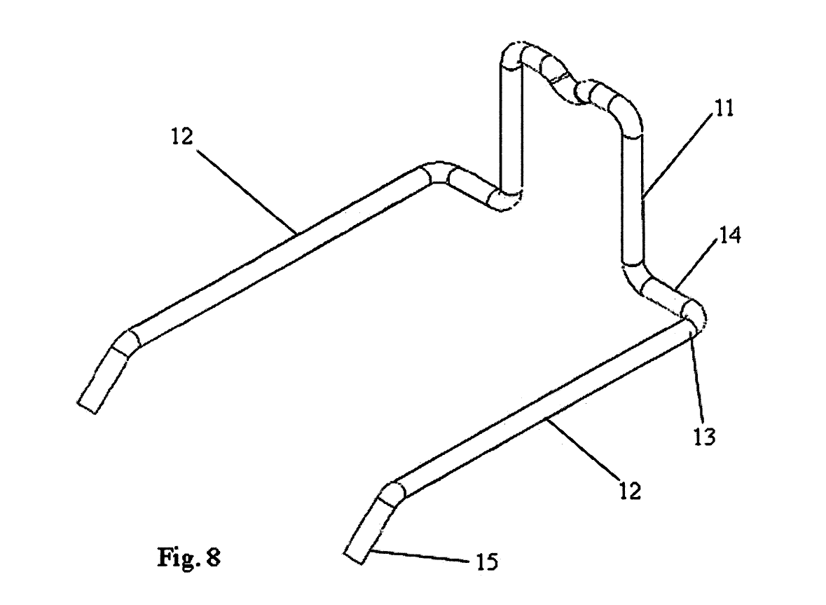

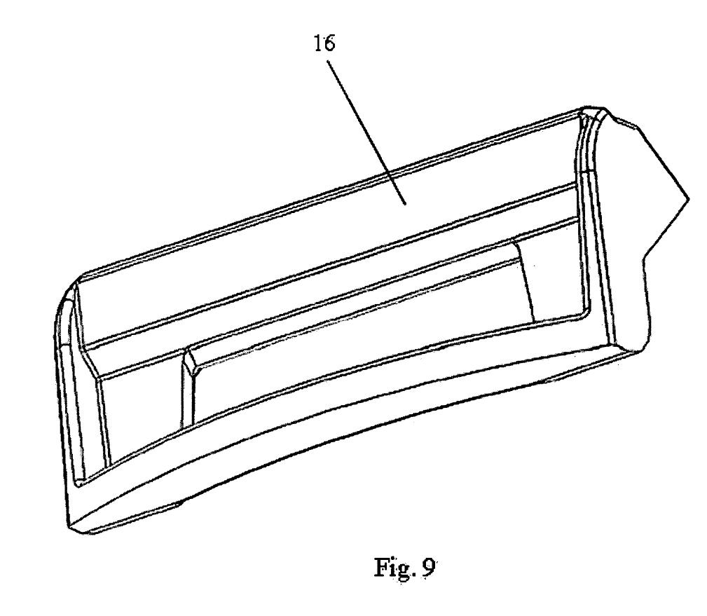

According to FIGS. 1, 2, 6 and 7 that show the embodiment of the trap from different viewing directions, the trap comprises a base plate 1 that is illustrated separately in FIGS. 3 and 4. In the region of its front section, the base plate 1 is provided with a bait receptacle 4 that lies on its longitudinal axis 2 and extends upward from the upper surface 3 of the base plate 1. Wall-like holding elements 6 extend parallel to the longitudinal edges 5 of the base plate 1 from approximately the longitudinal center of the base plate into the rear section of the base plate 1 on both sides, wherein the first axis 7, i.e., the pivoting axis of the striking device 8 of the trap, as well as the second axis 9, i.e., the pivoting axis of the trigger device 10 of the trap, are guided transverse to the longitudinal axis 2 of the base plate 1 in said holding elements. FIG. 8 shows most clearly that the striking device 8 is realized in the form of a bracket with a first arm 11 and two identical arms 12, the lower ends 13 of which are perpendicularly connected to sections 14 of the first arm 11. In the installation position of the striking device 8 into the trap (FIGS. 1 and 2), the first arm 11 is supported in the holding elements 6 of the base plate 1 with the sections 14, wherein the sections 14 extend transverse to the longitudinal axis 2 of the base plate 1 and form the first axis 7, i.e., the pivoting axis of the striking device 8. The upper ends 15 of the second arms 12 of the striking device 8 are connected to the striking part 16 of the striking device that is illustrated separately in FIG. 9.

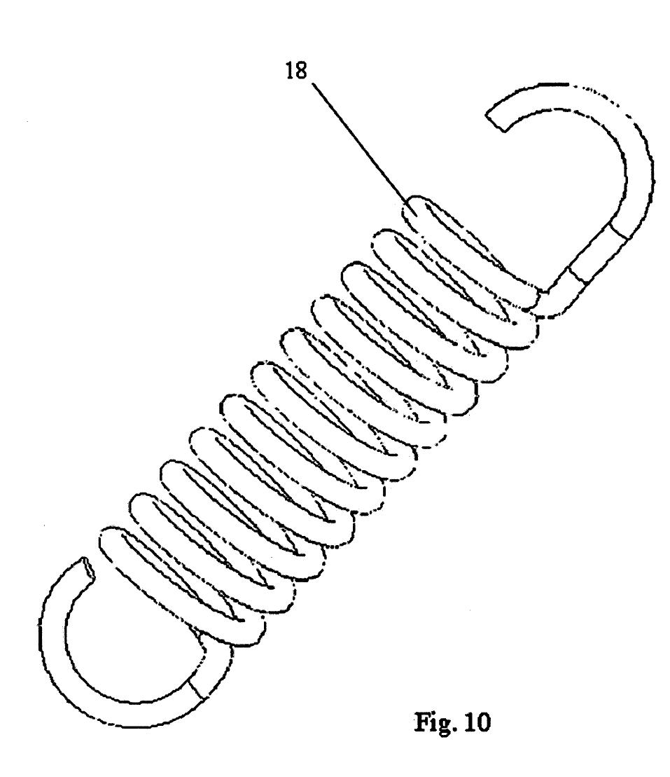

In FIG. 1, the striking device 8 is situated in its first, armed position, in which it is separably held due to the cooperation between the release element 17 holding the first arm 11 and the trigger device 10 that is in its idle position, namely as long as the tension spring 18 cannot pivot the striking device 8 into the second position shown in the FIG. 2. The tension spring is realized in the form of a coil spring as shown in FIG. 10 and its first and second mounting points 19 and 20 respectively lie on the first arm 11 of the striking device 8 and on the base plate 1.

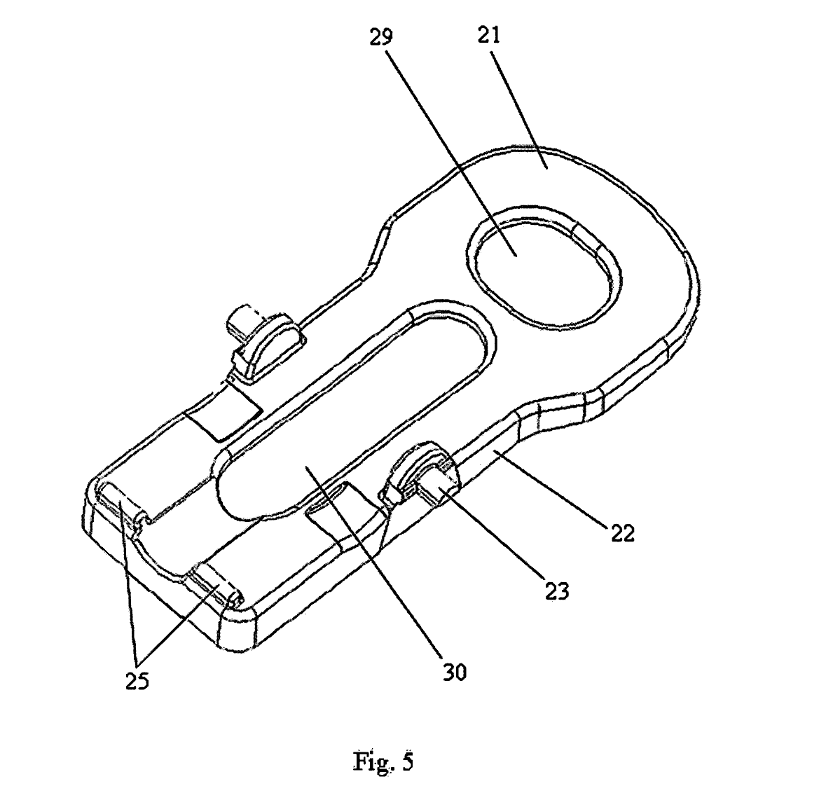

The trigger device 10 is realized in the form of a rocker-like plate, the underside 21 of which is illustrated in FIG. 5, wherein the horizontal projection of the trigger device corresponds to that of a conventional crown cap bottle opener. The plate 10 contains bearing bolts 23 that protrude from its two longitudinal edges 22 and serve for supporting the plate in the holding elements 6 of the base plate 1, wherein said bearing bolts simultaneously form the second axis 9 that serves for pivoting the plate 10 in a rocker-like fashion and is slightly offset referred to the center of the plate 10, namely in the direction toward its second end 24. On the second end 24 of plate 10, support elements 25 protrude from the underside 21 of the plate, and an abutment 27 extends upward from the opposite upper surface 26 of the plate 10. The plate 10 also contains an oval first recess 29 in the vicinity of its first end 28, as well as a second recess 30 that is spaced apart from the first recess and extends along the longitudinal center of the plate.

According to FIGS. 1 and 2, the plate 10 can be pivoted in the trap in a rocker-like fashion about the second axis 9 above the base plate 1, wherein said plate is arranged parallel to the base plate 1 in its idle position, and wherein the support elements 25 on the underside 21 of the plate 10 lie on the upper surface 3 of the base plate 1.

The oval first recess 29 of the plate 10 encompasses the receptacle 4 for the bait in such a way that the opening 31 of the receptacle 4 is constantly accessible.

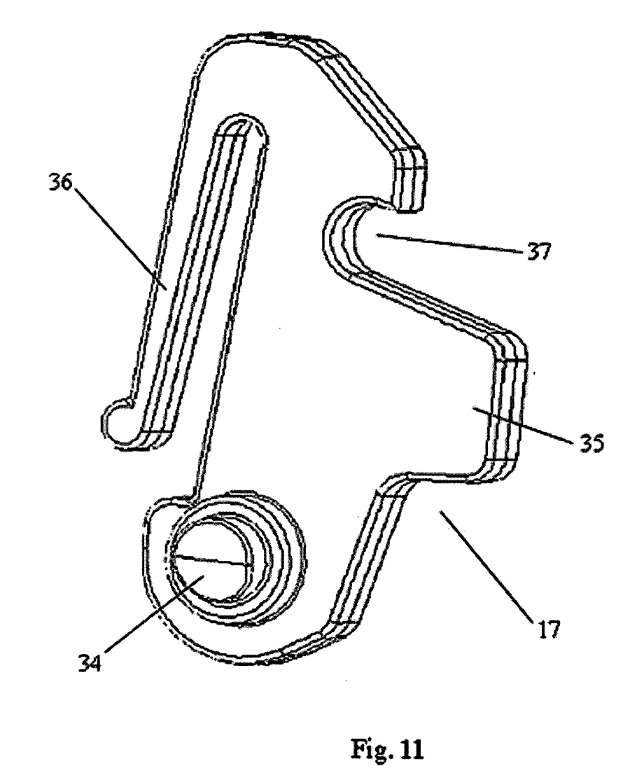

According to FIGS. 1-4, a holding device 33 is provided on the second end 32 of the base plate 1 adjacent to the second end 24 of the rocker-like plate 10, wherein said holding device extends upward from the upper surface 3 of the base plate, and wherein an elastic driving element that forms the release element 17 of the trap is eccentrically supported in the holding device such that it can be pivoted about a third axis 34. The driving element 17 is illustrated separately in FIG. 11 and contains a collar 35 that lies on the abutment 27 of the base plate 1 under the influence of the rotative moment of the driving element 17 when it is situated in its home position. A spring arm 36 is arranged on the driving element opposite of the collar 35.

In the idle position of the rocker-like plate 10, the first arm 11 of the striking device 8 that contains the first mounting point 19 of the tension spring. 18 is held in a groove 37 of the driving element 17 that is situated above the collar 35, and the striking device 8 consequently is fixed in its first, armed position as shown in FIG. 1. In the embodiment of the trap shown, the second arms 12 of the striking device 8 extend at an angle a of approximately 15° relative to the normal of the base plate 1 when the striking device 8 is situated in its first, armed position, wherein the second arms are inclined toward the second position of the striking device 8 as shown in FIG. 1. The first, the second and the third axis 7 and 9 and 34 of the trap are arranged horizontally referred to the base plate 1 and parallel to one another, wherein the first axis 7 is arranged between the second axis 9 and the third axis 34, and wherein the first axis 7 and the second axis 9 lie in one plane while the third axis 34 lies underneath the latter.

For example, if a mouse climbs onto the rocker-like plate 10 that is situated in its idle position from the base plate 1 in order to reach the bait in the receptacle 4, the instant rocking motion of the plate 10 causes the abutment 27 of plate 10 to act upon the collar 35 of the driving element 17 against the rotative moment of the driving element 17 that is situated in its release position. This causes the striking device 8 to instantly swing into its second position illustrated in FIG. 2 with a high striking force due to the effect of the tension spring 18 such that the mouse is killed instantly, i.e., in a humane fashion. During the rotational movement of the released driving element 17 into the release position, its spring arm 36 springably engages with a rear limit stop 38 of the holding device 33 of the driving element 17. The spring-back effect causes the driving element 17 that is supported in the holding element 33 and can be eccentrically pivoted about the third axis 34 to be turned back into the home position. Its rotative moment then returns the driving element into the home position, in which the collar 35 of the driving element 17 is engaged with the abutment 27 of the plate 10.

FIGS. 1-4 also show that wall-like elements 39 originating at the first end 28 of the rocker-like plate 10 may be provided on the base plate 1 along the respective longitudinal sides of the plate 10, wherein these wall-like elements extend over approximately one-third of the length of the plate 10. The wall-like elements 39 extend from the upper surface 3 of the base plate 1 to the plane at the elevation, at which the upper surface 26 of the rocker-like plate 10 lies in its idle position. The wall-like elements 39 are situated inside the striking device 8 when it is situated in its second position as shown in FIG. 2. When a mouse climbs toward the rocker-like plate 10 from one longitudinal side of the base plate 1 such that it acts upon said plate, the wall-like elements 39 form a guillotine-like unit that instantly kills the mouse in a humane fashion together with the striking device 8 that instantly swings into the second position.

According to FIG. 8, the base plate 1 may contain a recess 41 for handling the trap in the region of its first front edge 40.

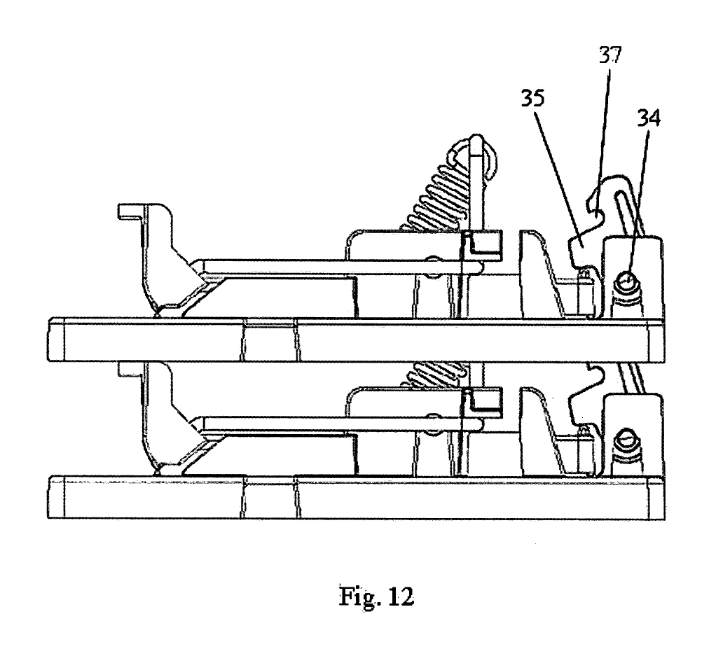

FIG. 12 shows that several (in this case two) identical traps can be stacked into a compact unit when the striking device 8 is situated in the first position shown in FIG. 2. In this compact unit, the base plates 1 of the stacked traps lie parallel to one another, and the first arm 11 of the striking device 8 respectively protrudes into another recess of the base plate 1 arranged directly thereon within the compact unit. The distance between the base plates 1 of the stacked traps is respectively smaller than the height of the striking part 16 of the striking device 8 referred to the upper surface 3 of the base plate 1 in the second position of the striking device 8.

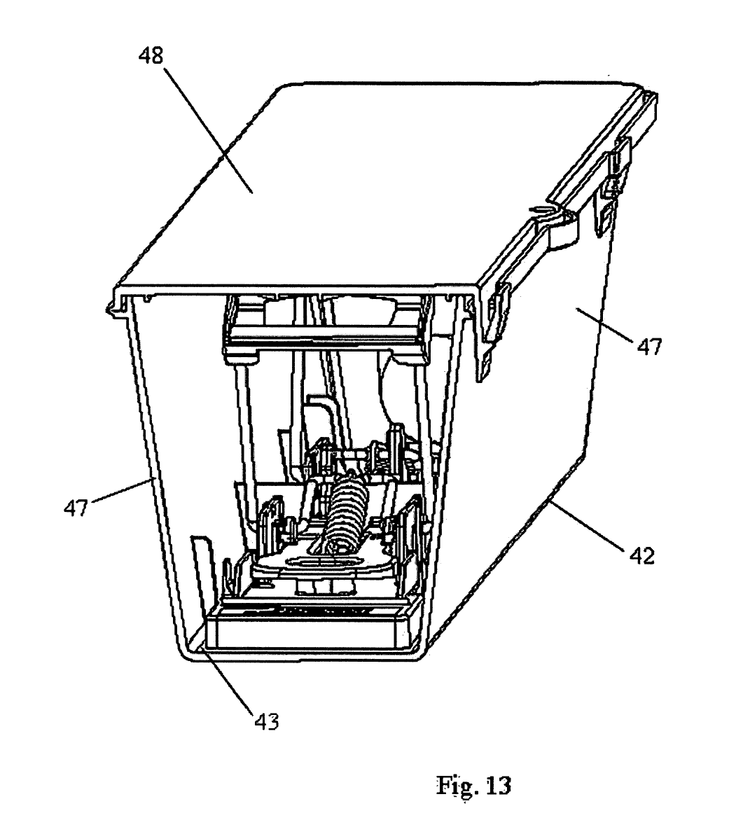

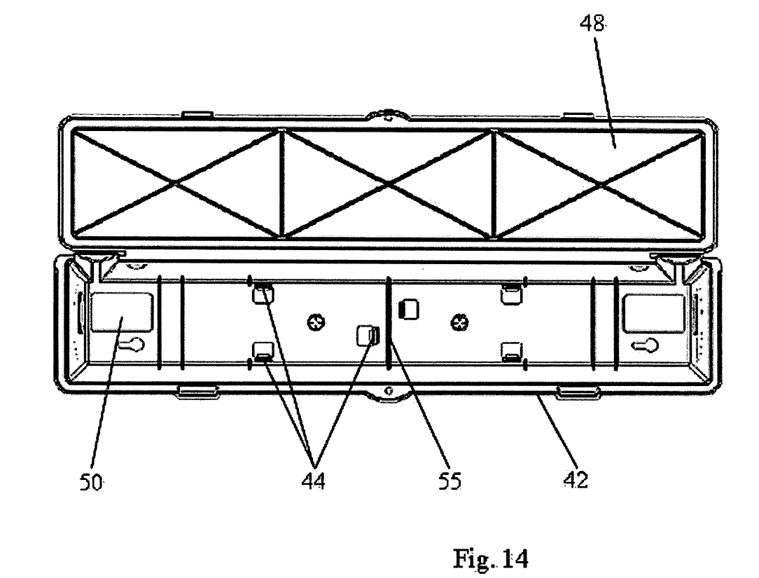

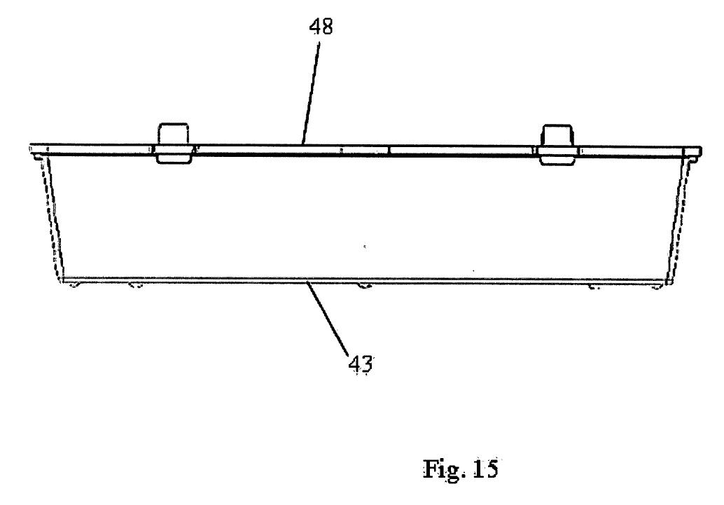

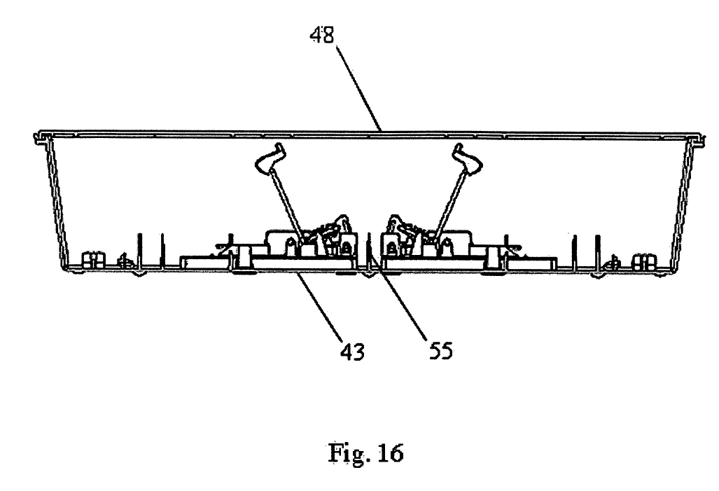

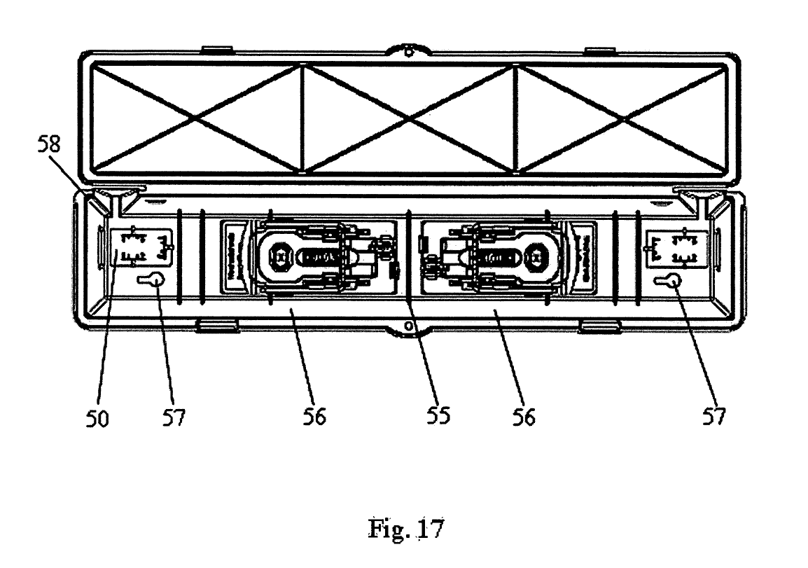

FIGS. 13-17 show an outer housing 42 that is realized in the form of a bait box and into which the trap can be removably inserted such that it is situated in a protected position. The housing bottom 43 is provided with locking elements 44 that engage into locking grooves 45 on each longitudinal edge 5 of the base plate 1 and on the second front edge 46 of the base plate 1 that is situated adjacent to the holding device 33 of the driving element 17 such that the trap is detachably locked on the housing bottom 43. According to FIG. 13, the side walls 47 of the housing 42 extend—if viewed in the form of a cross section through the housing 42—conically referred to the housing bottom 43, namely such that a rodent, e.g., a mouse, is not provided with a passage between the side walls 47 and the longitudinal sides of the trap inserted into the housing 42. The housing 42 contains a housing cover 48 (FIG. 14 ) that is hinged to one side wall 47 and makes it possible to securely cover the trap inserted into the housing 42 when the striking device 8 is situated in its first, armed position (FIG. 16) and in its second position or trapping position. The housing cover 48 can be separably locked in position (FIG. 15) by means of snap-on elements 49 that are arranged on the other side wall 47 of the housing 42 and on the housing cover 48. According to FIG. 17, the housing bottom 43 contains a recess 50 in the access region of the bait box that is situated in front of the first front edge 40 of the base plate 1 of the trap inserted into the housing 42. For example, if a mouse reaches the interior of the housing 42 through the opening 51 (FIG. 17) while the trap is in the operative position, the recess 50 causes the mouse to also continue walking on the natural ground of the trap installation site in the access region that lies within the housing 42, namely in the direction of the base plate 1 that contains the receptacle 4 with the bait. This means that the mouse is practically steered toward the rocker-like plate 10 of the trap, wherein the mouse is instantly killed in a humane fashion by the striking device 8 when it contacts this plate. Since the housing 42 can be closed with the housing cover 48, it is ensured that children, pets and animals other than those targeted cannot reach the animal cadaver in the trap. It is also ensured that the trap cannot be externally triggered with a finger and that the latter cannot be struck because the opening 51 of the housing 42 is spaced apart from the striking device 8 by a distance of more than 10 cm at all times, i.e., in its first, armed position and in its second position (trapping position). It is also impossible to reach and touch the mouse situated in the trap with the fingers.

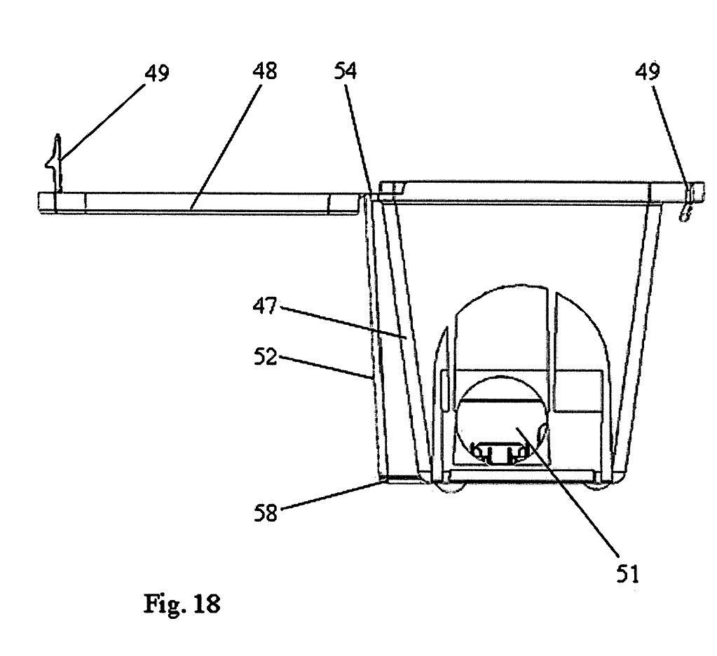

Due to the known edge contact behavior, e.g., of mice and rats, it is practical with respect to the efficiency of the trap, particularly in the poultry farming of ground-dwelling animals, to place the outer housing 42 of the trap on the ground such that it directly adjoins a building wall and the rodent to be trapped cannot pass between the side wall 47 of the housing 42 and the building wall. This can be ensured if the outer surface 52 of one of the side walls 48 of the housing 42 that are arranged conically referred to the housing bottom 43 extend—viewed in the form of a cross section through the housing 42—vertically upward from the housing bottom 43 on both of its longitudinal ends 54 and in alignment with its upper longitudinal edge 54 (FIG. 18), namely to such a height that the housing 42 can be flatly fixed on a building wall with the corresponding side wall 47.

FIG. 17 shows that the housing 42 of the trap may also be centrally divided into two identical housing halves 56 by means of a partition wall 55, wherein a trap of the described design is respectively positioned in each housing half in the form of a mirror arrangement. Key-shaped mounting holes 57 that are respectively arranged in the housing bottom 43 on its longitudinal end 58 make it possible to securely fix the housing 42 of the trap on the ground of the installation site.

### LIST OF REFERENCE SYMBOLS

1 Base plate

2 Longitudinal axis of the base plate

3 Upper surface of the base plate

4 Bait receptacle

5 Longitudinal edges of the base plate

6 Wall-like holding elements

7 First axis

8 Striking device

9 Second axis

10 Trigger device, rocker-like plate

11 First arm of the striking device

12 Second arms of the striking device

13 Lower end of the second arms

14 Sections of the first arm

15 Upper end of the second arms

16 Striking part

17 Release element, driving element

18 Tension spring

19 First mounting point of the tension spring

20 Second mounting point of the tension spring

21 Underside of the rocker-like plate

22 Longitudinal edges of the plate

23 Bearing bolts

24 Second end of the plate

25 Support elements

26 Upper surface of the plate

27 Abutment

28 First end of the rocker-like plate

29 First recess of the rocker-like plate

30 Second recess of the rocker-like plate

31 Opening of the receptacle

32 Second end of the base plate

33 Holding device

34 Third axis

35 Collar

36 Spring arm of the driving element

37 Groove

38 Limit stop of the holding device

39 Wall-like elements

40 First front edge of the base plate

41 Recess of the base plate

42 Outer housing of the trap

43 Housing bottom

44 Locking elements

45 Locking grooves

46 Second front edge of the base plate

47 Side walls of the housing

48 Housing cover

49 Snap-on elements

50 Recess of the housing bottom

51 Opening of the housing

52 Outer surface of a side wall

53 Longitudinal ends of the side wall

54 Upper longitudinal edge of the side wall

55 Partition wall of the housing

56 Housing halves

57 Mounting holes

58 Longitudinal ends of the housing bottom

59 Holding element of the base plate

α Angle of inclination of the second arm of the striking device

1. A trap for small rodents, particularly for mice and rats, with a base plate (1) that is provided with a receptacle (4) for accommodating a bait, with a striking device (8) that is supported on the base plate (1) such that it can be pivoted about a first axis (7), wherein the striking device can be subjected to the force of a tension spring (18) and released from a first, armed position when an animal acts upon a trigger device (10) such that it is pivoted about a second axis (9) supported on the base plate (1) from an idle position into a triggering position, in which a release element (17) that is engaged with the striking device (8) in the first, armed position can be pivoted by the trigger device (10) in such a way that the striking device (8) that can be pivoted about the first axis (7) is released from its first, armed position and the force of the tension spring (18) causes the striking device to instantly swing into a second position, in which it strikes and kills the animal, wherein the striking device (8) extending from the first axis (7) is provided with a first and a second arm (1 1 and 12), wherein a first mounting point (19) of the tension spring (18) is arranged on the end of the striking device (8) that can be turned by the first axis (7) of the first arm (11), wherein the second mounting point (20) of the tension spring (18) is arranged on the frame (1), wherein the line of force between the two mounting points (19 and 20) of the tension spring (18) extends through or in the vicinity of the first axis (7) when the striking device (8) is situated in its first, armed position, and wherein the trigger device (10) encompasses the opening (31) of the bait receptacle (4) at least in its idle position and the opening (31) of the bait receptacle (4) is freely accessible at least in the triggering position of the trigger device (10), characterized in that
the trigger device is formed by a plate (10) that can be pivoted about the second axis (9) of the base plate (1) in a rocker-like fashion, namely above the latter, and is arranged parallel to the base plate (1) in its idle position, wherein said plate contains a first recess (29) in the vicinity of its first end (28) which encompasses the opening (31) of the bait receptacle (4) of the base plate (1) such that it is always accessible, and wherein the opposite second end (24) of this plate contains an abutment (27) that extends upward from the upper surface (26) of the plate (10),
the release element is formed by an elastic driving element (17) that is eccentrically supported on the base plate (1) on a third axis (34) thereof in the vicinity of the second end (24) of the plate (10), namely such that its rotative moment causes the driving element to be prestressed into a home position, in which a collar (35) of the driving element (17) is engaged with the abutment (27) of the plate (10) and the striking device (8) is separably locked on the driving element (17) in its first, armed position, wherein the third axis (34) is arranged between the first end (28) of the rocker-like plate (10) and the first axis (7) and the second mounting point (20) of the tension spring (18) is arranged on the base plate (1) between the second axis (9) and the first end (28) of the plate (10) such that, when the first end (28) of the rocker-like plate (10) is acted upon in the direction toward the base plate (1), the collar (35) of the driving element (17) is acted upon by the abutment (27) of the plate (10) and the eccentrically supported driving element (17) is prestressed opposite to its rotative moment, namely into a position that releases the locked striking device (8) from its first, armed position, wherein the released striking device (8) instantly pivots into its second position due to the force of the tension spring (18), wherein a spring arm (36) of the driving element (17) that is arranged opposite to the collar (35) of the driving element (17) is tensioned in its release position, and wherein the driving element (17) is turned back into its home position due to the spring-back of the spring arm (36).

2. The trap according to claim 1, characterized in that a holding device (33) is preferably provided adjacent to the second end (24) of the rocker-like plate (10) on the second end (32) of the base plate (1) such that it extends upward from the upper surface (3) of said base plate, wherein the third axis (34) for eccentrically supporting the driving element (17) in a pivotable fashion is held on this holding device, and wherein the holding device also contains a limit stop (38) that is contacted by the spring arm (36) of the driving element (17) in its release position and tensions the spring arm due to its spring-back, namely such that the driving element (17) is turned into its home position.

3. The trap according to claim 1, characterized in that the first, the second and the third axis (7 and 9 and 34) are arranged horizontally referred to the base plate (1) in a parallel fashion, namely above the base plate (1), wherein the first axis (7) is arranged between the second axis and the third axis (9 and 34), and wherein the first and the second axis (7 and 9) lie in one plane while the third axis (34) is situated underneath the latter.

4. The trap according claim 1, characterized in that wall-like elements (39) originating at the first end (28) of the rocker-like plate (10) are arranged on the base plate (1) such that they respectively extend over approximately one-third of the length of the plate (10), wherein these wall-like elements extend upward from the upper surface (3) of the base plate (1) as far as the plane, in which the upper surface (26) of the rocker-like plate (10) lies in its home position, and wherein the wall-like elements (39) are situated inside the striking device (8) in its second position such that they form a guillotine-like unit for humanely killing the mouse together with the striking device (8) that instantly swings into its second position when a mouse approaches the rocker-like plate (10) from a longitudinal edge (5) of the base plate (1) and thusly acts upon the trigger device (10).

5. The trap according claim 1, characterized in that the first and the second arms (11 and 12) of the striking device (8) form a right angle, wherein the second arms (12) are inclined relative to the normal of the base plate (1) by an angle a of approximately 15°, namely in the direction of the second position of the striking device (8), in the first, armed position of the striking device.

6. The trap according to claim 1, characterized in that the rocker-like plate (10) contains a second recess (29) that extends in the direction of its longitudinal axis and in which a holding element (59) is accommodated which extends upward from the upper surface (3) of the base plate (1), wherein the second mounting point (20) of the tension spring (18) is situated on said holding element.

7. The trap according to claim 1, characterized in that a plurality of identical traps can be stacked into a compact unit when the striking device (8) of the trap is situated in the second position, in that the base plates (1) of the stacked traps lie parallel to one another and the first arm (12) of the striking device (8) is respectively accommodated in a recess (41) in the base plate (1) of the trap lying directly thereon within the compact unit, and in that the distance between the base plates (1) of the stacked traps is respectively smaller than the height of the striking part (16) of the striking device (8) referred to the upper surface (3) of the base plate (1 ) in the second position of the striking device (8).

8. The trap according to claim 1 with an exterior housing, into which the trap can be inserted such that it is arranged in a protected location, wherein the housing (42) is provided with at least a first opening (51), and wherein the size and the arrangement of said opening are chosen such that animals of a desired maximum size are able to gain access to the trigger device (10) of the trap, characterized in that the housing (42) is formed by a bait box with locking elements (41) that are arranged on the housing bottom (43) and engage in a separably interlocking fashion into locking grooves (45) on each longitudinal edge (5) of the base plate (1), as well as on the second lateral edge (46) of the base plate (1) of the trap that is situated adjacent to the release element (17), when the trap is inserted into the housing (42), wherein the bait box has—if viewed in the form of a cross section through the housing (42)—side walls (47) that extend conically referred to the housing bottom (43) such that a rodent, e.g., a mouse, is unable to pass between the side walls (47) of the housing (33) and the longitudinal sides of the trap inserted into the latter, with a housing cover (48) that is hinged to one side wall (47) of the housing (2) and securely covers the trap inserted into the housing (42) in the first, armed position as well as the second position (trapping position) of the striking device (8), wherein the housing cover can be removably attached by means of corresponding snap-on elements (49) arranged on the housing cover (48) and on the other side wall (47) of the housing (42), wherein the housing bottom (43) is provided with a recess (50) in the access region that is situated in front of the first front edge (40) of the base plate (1) of the trap inserted into the housing (42) such that a mouse entering the housing (42) through the opening (51) is able to continue walking on the natural ground of the respective trap installation site in this access region, namely in the direction of the base plate (1) with the receptacle (4) containing the bait and consequently in the direction of the trigger device (10) of the trap.

9. The trap according to claim 8, characterized in that the housing (42) of the trap is divided into two identical housing halves (56) by means of a central partition wall (55) such that a mirror arrangement of two identically designed traps can be realized in the housing (42).

10. The trap according to claim 8, characterized in that the outer surface (52) of one of the side walls (47) of the housing (42) that are arranged conically referred to the housing bottom (43) extends—if viewed in the form of a cross section through the housing (42) of the trap—vertically upward from the housing bottom (43) on both of its longitudinal ends (58) and in alignment with its upper longitudinal edge (54), namely to such a height that the housing (42) can be flatly fixed on a building wall with the corresponding side wall (47) of the housing (42) and the housing (42) can be inserted into identical housings (42) for stacking purposes.

11. The trap according to claim 2, characterized in that the first, the second and the third axis (7 and 9 and 34) are arranged horizontally referred to the base plate (1) in a parallel fashion, namely above the base plate (1), wherein the first axis (7) is arranged between the second axis and the third axis (9 and 34), and wherein the first and the second axis (7 and 9) lie in one plane while the third axis (34) is situated underneath the latter.

12. The trap according to claim 2, characterized in that a plurality of identical traps can be stacked into a compact unit when the striking device (8) of the trap is situated in the second position, in that the base plates (1) of the stacked traps lie parallel to one another and the first arm (12) of the striking device (8) is respectively accommodated in a recess (41) in the base plate (1) of the trap lying directly thereon within the compact unit, and in that the distance between the base plates (1) of the stacked traps is respectively smaller than the height of the striking part (16) of the striking device (8) referred to the upper surface (3) of the base plate (1) in the second position of the striking device (8).

13. The trap according to claim 3, characterized in that a plurality of identical traps can be stacked into a compact unit when the striking device (8) of the trap is situated in the second position, in that the base plates (1 ) of the stacked traps lie parallel to one another and the first arm (12) of the striking device (8) is respectively accommodated in a recess (41) in the base plate (1) of the trap lying directly thereon within the compact unit, and in that the distance between the base plates (1) of the stacked traps is respectively smaller than the height of the striking part (16) of the striking device (8) referred to the upper surface (3) of the base plate (1) in the second position of the striking device (8).

14. The trap according to claim 4, characterized in that a plurality of identical traps can be stacked into a compact unit when the striking device (8) of the trap is situated in the second position, in that the base plates (1 ) of the stacked traps lie parallel to one another and the first arm (12) of the striking device (8) is respectively accommodated in a recess (41) in the base plate (1) of the trap lying directly thereon within the compact unit, and in that the distance between the base plates (1 ) of the stacked traps is respectively smaller than the height of the striking part (16) of the striking device (8) referred to the upper surface (3) of the base plate (1) in the second position of the striking device (8).

15. The trap according to claim 5, characterized in that a plurality of identical traps can be stacked into a compact unit when the striking device (8) of the trap is situated in the second position, in that the base plates (1 ) of the stacked traps lie parallel to one another and the first arm (12) of the striking device (8) is respectively accommodated in a recess (41) in the base plate (1) of the trap lying directly thereon within the compact unit, and in that the distance between the base plates (1) of the stacked traps is respectively smaller than the height of the striking part (16) of the striking device (8) referred to the upper surface (3) of the base plate (1) in the second position of the striking device (8).

16. The trap according to claim 6, characterized in that a plurality of identical traps can be stacked into a compact unit when the striking device (8) of the trap is situated in the second position, in that the base plates (1) of the stacked traps lie parallel to one another and the first arm (12) of the striking device (8) is respectively accommodated in a recess (41) in the base plate (1) of the trap lying directly thereon within the compact unit, and in that the distance between the base plates (1) of the stacked traps is respectively smaller than the height of the striking part (16) of the striking device (8) referred to the upper surface (3) of the base plate (1) in the second position of the striking device (8).

17. The trap according to claim 2 with an exterior housing, into which the trap can be inserted such that it is arranged in a protected location, wherein the housing (42) is provided with at least a first opening (51), and wherein the size and the arrangement of said opening are chosen such that animals of a desired maximum size are able to gain access to the trigger device (10) of the trap, characterized in that the housing (42) is formed by a bait box with locking elements (41) that are arranged on the housing bottom (43) and engage in a separably interlocking fashion into locking grooves (45) on each longitudinal edge (5) of the base plate (1), as well as on the second lateral edge (46) of the base plate (1) of the trap that is situated adjacent to the release element (17), when the trap is inserted into the housing (42), wherein the bait box has—if viewed in the form of a cross section through the housing (42)—side walls (47) that extend conically referred to the housing bottom (43) such that a rodent, e.g., a mouse, is unable to pass between the side walls (47) of the housing (33) and the longitudinal sides of the trap inserted into the latter, with a housing cover (48) that is hinged to one side wall (47) of the housing (2) and securely covers the trap inserted into the housing (42) in the first, armed position as well as the second position (trapping position) of the striking device (8), wherein the housing cover can be removably attached by means of corresponding snap-on elements (49) arranged on the housing cover (48) and on the other side wall (47) of the housing (42), wherein the housing bottom (43) is provided with a recess (50) in the access region that is situated in front of the first front edge (40) of the base plate (1) of the trap inserted into the housing (42) such that a mouse entering the housing (42) through the opening (51) is able to continue walking on the natural ground of the respective trap installation site in this access region, namely in the direction of the base plate (1) with the receptacle (4) containing the bait and consequently in the direction of the trigger device (10) of the trap.

18. The trap according to claim 3 with an exterior housing, into which the trap can be inserted such that it is arranged in a protected location, wherein the housing (42) is provided with at least a first opening (51), and wherein the size and the arrangement of said opening are chosen such that animals of a desired maximum size are able to gain access to the trigger device (10) of the trap, characterized in that the housing (42) is formed by a bait box with locking elements (41) that are arranged on the housing bottom (43) and engage in a separably interlocking fashion into locking grooves (45) on each longitudinal edge (5) of the base plate (1), as well as on the second lateral edge (46) of the base plate (1) of the trap that is situated adjacent to the release element (17), when the trap is inserted into the housing (42), wherein the bait box has—if viewed in the form of a cross section through the housing (42)—side walls (47) that extend conically referred to the housing bottom (43) such that a rodent, e.g., a mouse, is unable to pass between the side walls (47) of the housing (33) and the longitudinal sides of the trap inserted into the latter, with a housing cover (48) that is hinged to one side wall (47) of the housing (2) and securely covers the trap inserted into the housing (42) in the first, armed position as well as the second position (trapping position) of the striking device (8), wherein the housing cover can be removably attached by means of corresponding snap-on elements (49) arranged on the housing cover (48) and on the other side wall (47) of the housing (42), wherein the housing bottom (43) is provided with a recess (50) in the access region that is situated in front of the first front edge (40) of the base plate (1) of the trap inserted into the housing (42) such that a mouse entering the housing (42) through the opening (51) is able to continue walking on the natural ground of the respective trap installation site in this access region, namely in the direction of the base plate (1) with the receptacle (4) containing the bait and consequently in the direction of the trigger device (10) of the trap.

19. The trap according to claim 4 with an exterior housing, into which the trap can be inserted such that it is arranged in a protected location, wherein the housing (42) is provided with at least a first opening (51), and wherein the size and the arrangement of said opening are chosen such that animals of a desired maximum size are able to gain access to the trigger device (10) of the trap, characterized in that the housing (42) is formed by a bait box with locking elements (41) that are arranged on the housing bottom (43) and engage in a separably interlocking fashion into locking grooves (45) on each longitudinal edge (5) of the base plate (1), as well as on the second lateral edge (46) of the base plate (1) of the trap that is situated adjacent to the release element (17), when the trap is inserted into the housing (42), wherein the bait box has—if viewed in the form of a cross section through the housing (42)—side walls (47) that extend conically referred to the housing bottom (43) such that a rodent, e.g., a mouse, is unable to pass between the side walls (47) of the housing (33) and the longitudinal sides of the trap inserted into the latter, with a housing cover (48) that is hinged to one side wall (47) of the housing (2) and securely covers the trap inserted into the housing (42) in the first, armed position as well as the second position (trapping position) of the striking device (8), wherein the housing cover can be removably attached by means of corresponding snap-on elements (49) arranged on the housing cover (48) and on the other side wall (47) of the housing (42), wherein the housing bottom (43) is provided with a recess (50) in the access region that is situated in front of the first front edge (40) of the base plate (1) of the trap inserted into the housing (42) such that a mouse entering the housing (42) through the opening (51) is able to continue walking on the natural ground of the respective trap installation site in this access region, namely in the direction of the base plate (1) with the receptacle (4) containing the bait and consequently in the direction of the trigger device (10) of the trap.

20. The trap according to claim 5 with an exterior housing, into which the trap can be inserted such that it is arranged in a protected location, wherein the housing (42) is provided with at least a first opening (51), and wherein the size and the arrangement of said opening are chosen such that animals of a desired maximum size are able to gain access to the trigger device (10) of the trap, characterized in that the housing (42) is formed by a bait box with locking elements (41) that are arranged on the housing bottom (43) and engage in a separably interlocking fashion into locking grooves (45) on each longitudinal edge (5) of the base plate (1), as well as on the second lateral edge (46) of the base plate (1) of the trap that is situated adjacent to the release element (17), when the trap is inserted into the housing (42), wherein the bait box has—if viewed in the form of a cross section through the housing (42)—side walls (47) that extend conically referred to the housing bottom (43) such that a rodent, e.g., a mouse, is unable to pass between the side walls (47) of the housing (33) and the longitudinal sides of the trap inserted into the latter, with a housing cover (48) that is hinged to one side wall (47) of the housing (2) and securely covers the trap inserted into the housing (42) in the first, armed position as well as the second position (trapping position) of the striking device (8), wherein the housing cover can be removably attached by means of corresponding snap-on elements (49) arranged on the housing cover (48) and on the other side wall (47) of the housing (42), wherein the housing bottom (43) is provided with a recess (50) in the access region that is situated in front of the first front edge (40) of the base plate (1) of the trap inserted into the housing (42) such that a mouse entering the housing (42) through the opening (51) is able to continue walking on the natural ground of the respective trap installation site in this access region, namely in the direction of the base plate (1) with the receptacle (4) containing the bait and consequently in the direction of the trigger device (10) of the trap.

21. The trap according to claim 6 with an exterior housing, into which the trap can be inserted such that it is arranged in a protected location, wherein the housing (42) is provided with at least a first opening (51), and wherein the size and the arrangement of said opening are chosen such that animals of a desired maximum size are able to gain access to the trigger device (10) of the trap, characterized in that the housing (42) is formed by a bait box with locking elements (41) that are arranged on the housing bottom (43) and engage in a separably interlocking fashion into locking grooves (45) on each longitudinal edge (5) of the base plate (1), as well as on the second lateral edge (46) of the base plate (1) of the trap that is situated adjacent to the release element (17), when the trap is inserted into the housing (42), wherein the bait box has—if viewed in the form of a cross section through the housing (42)—side walls (47) that extend conically referred to the housing bottom (43) such that a rodent, e.g., a mouse, is unable to pass between the side walls (47) of the housing (33) and the longitudinal sides of the trap inserted into the latter, with a housing cover (48) that is hinged to one side wall (47) of the housing (2) and securely covers the trap inserted into the housing (42) in the first, armed position as well as the second position (trapping position) of the striking device (8), wherein the housing cover can be removably attached by means of corresponding snap-on elements (49) arranged on the housing cover (48) and on the other side wall (47) of the housing (42), wherein the housing bottom (43) is provided with a recess (50) in the access region that is situated in front of the first front edge (40) of the base plate (1) of the trap inserted into the housing (42) such that a mouse entering the housing (42) through the opening (51) is able to continue walking on the natural ground of the respective trap installation site in this access region, namely in the direction of the base plate (1) with the receptacle (4) containing the bait and consequently in the direction of the trigger device (10) of the trap.

22. The trap according to claim 9, characterized in that the outer surface (52) of one of the side walls (47) of the housing (42) that are arranged conically referred to the housing bottom (43) extends—if viewed in the form of a cross section through the housing (42) of the trap—vertically upward from the housing bottom (43) on both of its longitudinal ends (58) and in alignment with its upper longitudinal edge (54), namely to such a height that the housing (42) can be flatly fixed on a building wall with the corresponding side wall (47) of the housing (42) and the housing (42) can be inserted into identical housings (42) for stacking purposes.
